(19) United States
(12) Patent Application Publication
(10) Pub. No.: US 2025/0278699 A1
(43) Pub. Date: Sep. 4, 2025

(54) AUTOMATED USER GROUP MANAGEMENT FOR EMAIL AND CALENDAR SERVER SOLUTIONS

(71) Applicant: The PNC Financial Services Group, Inc., Pittsburgh, PA (US)

(72) Inventors: Kathleen Sacco, Pittsburgh, PA (US); Scott Kinross, Severna Park, MD (US); Stephen Kohn, Hockessin, DE (US); Chris Kirkpatrick, Pulaski, TN (US); David John Gerena, Pittsburgh, PA (US)

(21) Appl. No.: 18/802,937

(22) Filed: Aug. 13, 2024

Related U.S. Application Data
(60) Provisional application No. 63/561,028, filed on Mar. 4, 2024.

(51) Int. Cl. G06Q 10/107; G06Q 10/1093

(52) U.S. Cl. CPC G06Q 10/107; G06Q 10/1093

(57) ABSTRACT

Systems and methods automate user and group creation for enterprises utilizing advanced email and calendar server solution servers in large enterprise systems. A server can: receive at least one file from at least one of the at least one database; read the at least one file; based on the at least one file, execute an automated periodic process to: determine a total number of users in a group of the groups; add at least one user from the at least one file to the group of the groups, based on the total number of users in the group being below the maximum number of users per group; and add at least one user in a subsequent group of the groups, based on the total number of users in the group not being below the maximum number of users per group.

### PRIORITY CLAIM

The present application claims priority to U.S. provisional patent application Ser. No. 63/561,028, filed Mar. 4, 2024, which is incorporated herein by reference.

### BACKGROUND

Email, messaging and calendaring server systems (also referred to herein as “email and calendar server solution(s)” or “email and calendaring platform”) are deployed frequently by enterprises, such as businesses, corporations and large organizations. These email and calendar server solutions are not limited to email and calendar management only, but allow task management creation, and synchronization of meetings and the like. An example of such an emailing and calendaring system is Microsoft Exchange, which is designed to manage the sending and receiving of emails on the back-end, to provide email storage and synchronization, allow creation and management of email and calendar groups that users can be added to, and facilitate the mass management of users via these groups. Such email/messaging and calendaring platforms can be hosted on-premises, on the cloud or both. On-premises versions of such systems allow the use of hardware owned, controlled, and managed by the enterprise or organization deploying the email and calendar server solution.

### SUMMARY

In one general aspect, the present invention is directed to computer-implemented systems and methods for automated creation, management, and synchronization of email and calendaring groups in enterprise systems deploying email and calendar server solution(s). In various aspects the present disclosure is further directed to the automated maintenance/updating of created groups periodically or upon specific events in the enterprise system. This can include determining group size limits set by the email and calendar server solution, creating one or more groups automatically based on detected or desired user size, then automatically placing users in created groups based on one or more criteria.

In some aspects, what is disclosed are automated systems and methods to update the groups and/or users in the created groups. These automated can ensure that these groups are maintained and kept up-to-date periodically and automatically without any user intervention once they have been created. This automated maintenance can comprise for example receiving various logs from a mainframe of an enterprise and synchronizing the users in the created groups with those received from local databases, updating the data of the deployed email and calendar server solution.

These and other benefits that can be realized through various embodiments of the present invention will be apparent from the description that follows.

### BRIEF DESCRIPTION OF DRAWINGS

Various embodiments of the present invention are described herein by example in connection with the following figures.

FIG. 1 illustrates one embodiment of an architecture of an enterprise system for autonomous creation and management of users and groups for an email and calendaring platform.

FIG. 2 illustrates in a diagrammatical format, one embodiment of a method of autonomously creating and managing users and groups for systems using an email and calendaring platform.

FIG. 3 illustrates one embodiment of a flow diagram illustrating a method for automated user and/or group creation for an enterprise using an email and calendaring system.

FIG. 4 illustrates one embodiment of a flow diagram illustrating a method for automated maintenance of user and/or groups for an enterprise using an email and calendaring system.

FIG. 5 is a block diagram of a computer apparatus with data processing subsystems or components, according to at least one aspect of the present disclosure.

FIG. 6 is a diagrammatic representation of an example system that includes a host machine within which a set of instructions to perform any one or more of the methodologies discussed herein may be executed, according to at least one aspect of the present disclosure.

### DETAILED DESCRIPTION

Email and calendar server solutions (abbreviated as “server solutions” or “server systems”) are applications and/or systems to facilitate the sending, receiving, and management of emails and calendars. These solutions act as intermediaries between email senders and receivers, providing a secure communication channel for emails to be stored and routed. These solutions can also include features such as spam filtering, antivirus scanning, storage limits for individual users, message forwarding rules, and other services. They can be available as an on-premises solution as an email or messaging and calendaring platform or server or can be provided as a cloud or off-premises solution hosted on a cloud or external network. Examples of these solutions can include Microsoft Exchange™, Google Workspace™, Ice Warp™, Kerio Connect™, and Amazon Workmail™.

One purpose for the deployment of these server solutions by businesses, enterprises and other organizations and agencies is to create, organize, interact with, and manage user email and calendar accounts for their employees or associated partners. For example each employee is usually associated with a user account, and multiple users accounts can be grouped together in groups, where calendar invites or emails can be pushed on a group-wide level to multiple users in a simplified, streamlined group-by-group basis, where a mass calendar invite, for example for a meeting, or a mass email, can be sent to all members of a group at once, by pushing out emails and calendars at a group level, including everyone in the group.

However, these server solutions come with limitations. One example of such a limitation is that these are server solutions are generally vendor-provided solutions that set limits on various things such as the size of users that can be allowed in groups, the type of users allowed in a group or a limit on the number of users or of a certain type of user in a group, as well as restrictions on how to update or service groups, how many people can be added to a certain calendar invite or emailing list, and the like. Because of these restrictions, businesses or enterprises that deploy these server solutions cannot control, manage and/or create group sizes beyond the limits imposed by the deployed sever solution and therefore, for example, cannot invite all their employees at once to a calendar or meeting if the number of employees exceed the number allowed in a group. When the number of employees number in the tens of thousands, for example, it becomes very difficult if not impossible to add users to hundreds of groups manually, and then manage and update these groups and use group-level functionalities such as emailing everyone in a group, or adding everyone to a calendar that is in a group when not all users can be added to these groups based on number and/or type limits.

The present disclosure provides solutions for automated group creation and management that allows enterprises to automatically create and manage users and groups for email and calendar server solutions, as well as automatically and periodically maintain and service these users and/or groups.

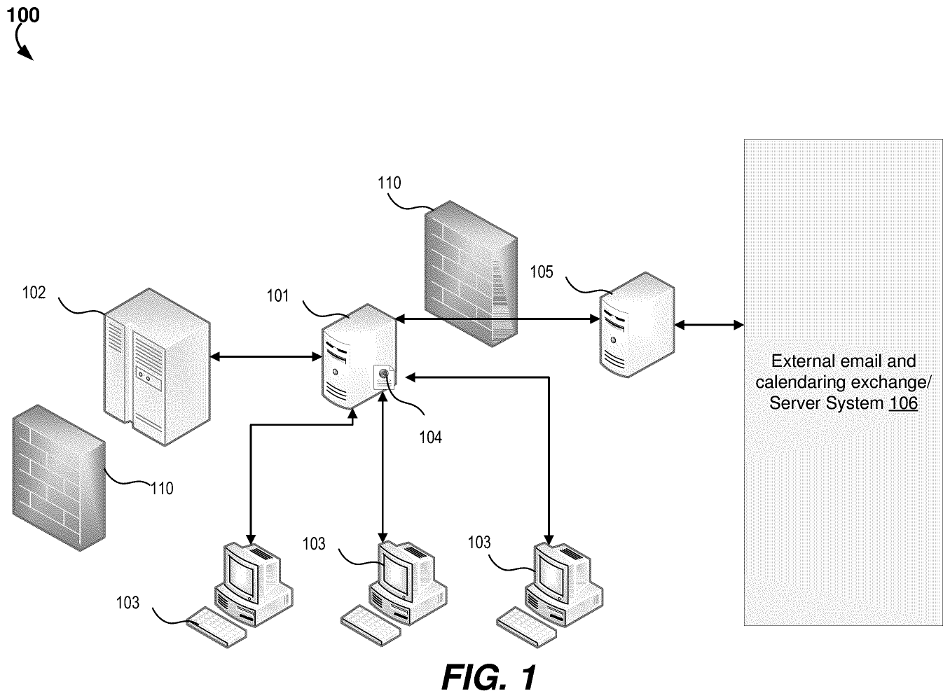

FIG. 1 illustrates one embodiment of an architecture for an enterprise system 120 for autonomous creation and management of users and groups for an email/messaging and calendaring platform. In several embodiments, the structure of architecture of enterprise system 100 includes an enterprise server 101 (“server 101”) that is connected to one or more computing devices 103 and a database and/or mainframe 102. Enterprise server 101 can run various applications, applets processes, jobs, code/instructions, and scripts (these all collectively and interchangeably referred to herein as a “script 104”). Some scripts 104 may be automated and/or executed by one or more bots deployed on server 101, for example a PowerShell script that is executed by a bot or any other suitable mechanism, or module.

In several embodiments server 101 is connected to an external server, such as SMTP server 105 (or any other server belonging to a network of the email and calendar server solutions facilitating emailing, calendaring, task creation and other such functionalities and services) and may in turn be connected to one or more nodes or components of an external email and calendar server solution or system 106. Enterprise system 100 can also include one or more firewalls 110 or other network security system 110 between the enterprise system 100 and external networks or other systems such as the wider internet.

A maximum threshold (also “max threshold”) as discussed herein generally refers to a simple max threshold that refers to a maximum number of users that can be added or assigned to a group—is a max user per group number. The max threshold is generally (but not always) set by the email and calendar server system. However, in some embodiments of the present disclosure, a maximum threshold can be a complex max threshold that can also include not only one generic numerical maximum but can also incorporate rules about various different user types, with varying numerical thresholds for each type, e.g. a maximum of 1 admin type per group, but a total number of users of 1000. It is to be understood that when referring to a maximum threshold in this disclosure, this can include a simple and/or a complex max threshold.

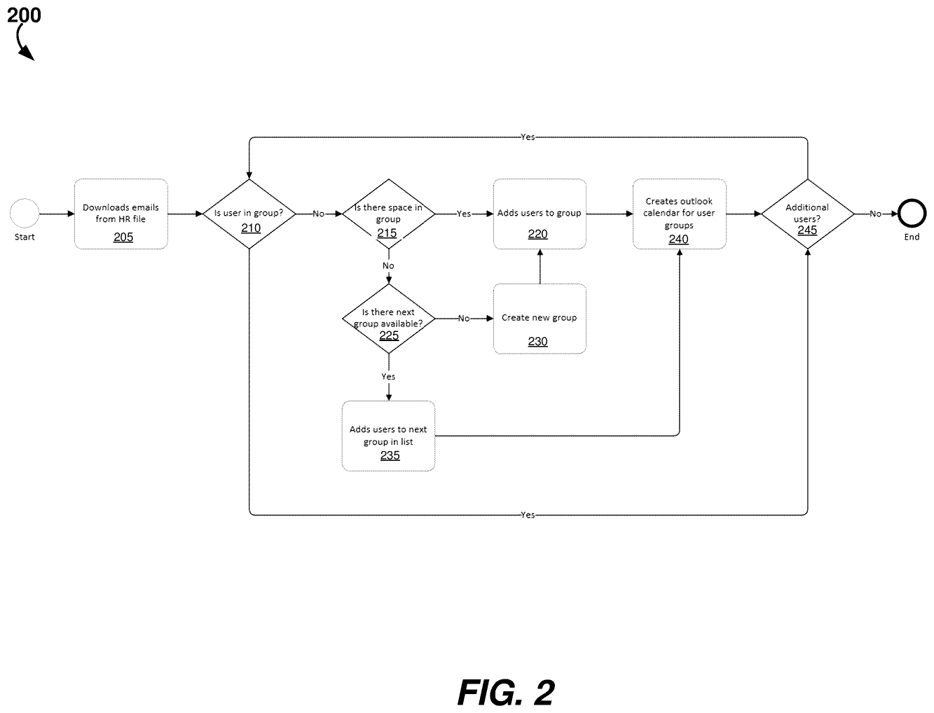

FIG. 2 illustrates in a diagrammatical format, one embodiment of a method 200 of autonomously creating and managing users and groups for systems that use or deploy an email/messaging and calendaring platform. With reference now primarily to FIG. 2 alongside FIG. 1, Method 200 can include deploying an automated script, programmed bot, application, applet, or other running code to undertake method 200 on, and by architecture 100, FIG. 1. Method 200 can, in several embodiments, be initiated automatically (for example as a scheduled job) or initiated manually by an administrator or user, for example an administrator using the one or more computing devices 103, FIG. 1. Method 200 may be triggered autonomously on, and/or by a server, e.g., enterprise server 101, FIG. 1, to organize, create, and mange user groups for email and calendar server systems where these server systems limit the number and/or types of users per group.

With continued reference now to FIG. 2 alongside FIG. 1, method 200 when executed may include downloading or otherwise receiving 205 emails, data and user logs, and other files that can include personnel records user data or user data objects. This can include receiving, for example by a server such as enterprise server 101, FIG. 1, these files from an enterprise database or enterprise mainframe, such as database/mainframe 102, FIG. 1, and/or from the one or more computing devices 103, FIG. 1. Downloading or receiving 205 can including reading these files, but reading files can be carried out separately/independently as well in other embodiments without having to first receive or download the files, for example if the reading component already possesses the files to be read.

Continuing to refer primarily to FIG. 2 alongside FIG. 1, once the files are read, the method 200 can automatically execute a script, such as script 104, FIG. 1, which can iterate through each user in the list or file to determine or detect 210 whether an identified user is already in a group associated with the email and calendaring server system, this information can be received or read from the file(s) in order for this determination 210 to be made. If it is determined 205 that the user is not assigned to a group already, then method 200 can also include determining 215 whether there is availability in a group based on at least a max threshold, where in various aspects, determining 215 can comprise iterating through a list, directories, or files of already created groups to determine the next group that has a current number of users below a maximum threshold and thus with space for a new user to be added or assigned to it. This can include determining that the group has not reached the maximum threshold based on either or both of the number or type of users for a group as set by the email and calendar server solution, i.e., determining 215 can comprise looking for a group below a maximum threshold, or iteratively, or sequentially look for or the next group below the max threshold among the list of groups.

If and upon finding a group below the maximum threshold, the current user in the file being assigned, assigned or added 220 to the group. If the current group being examined in the iterative framework, is at the threshold number of maximum allowable users or types of users, then the method 200 looks and examines the next group in the list or the next group available to determine 225 whether this next group has a number of users below the max threshold. If this next group has space for the current user being placed in a group, then the user is assigned or added 235 to this next group. However, if method 200 iterates through all the groups without finding a group where a user can be placed, i.e., a group with a number of users under the max threshold, then a new group can be automatically created 230, where the user can then be added 220 to this new group. As already discussed in this disclosure, a maximum threshold of a number of users, can include or take into account the number of users, the type of users allowed, and/or the rules set by the enterprise and/or the email and calendar server solution for how many users and/or of what type are allowed in a group(s).

In various embodiments, the automated method 200 can create 240 and/or push a calendar on a group-level to any of the created groups of the server systems. Creation 240 can also comprise creating tasks, emails, meetings, jobs and other functions that can be pushed to at least one of the groups of the server systems at a group level that captures all users within those groups. Method 200 may also include a check 245 for additional users from the files or a check 245 for new files or information that can also be added or moved within groups via the same aforementioned processes 210-240.

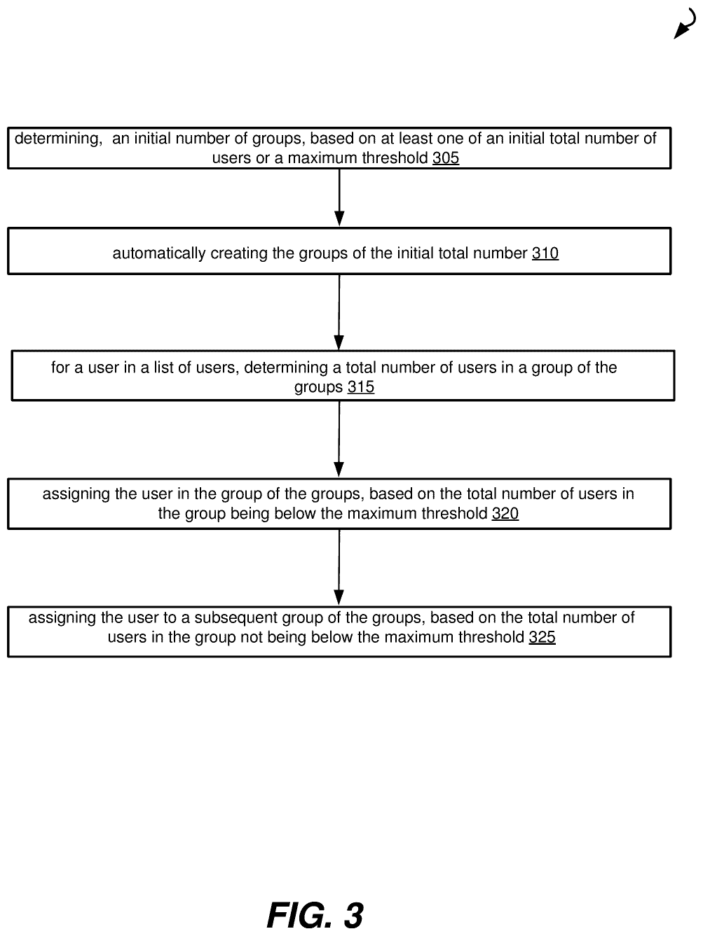

FIG. 3 illustrates one embodiment of a flow diagram illustrating a method for automated user and/or group creation for an enterprise using an email and calendaring system. Primarily referring to FIG. 3 in conjunction with FIG. 1. In various aspects, method 300 comprises determining 305 an initial number of groups, based on at least one of an initial total number of users, types of users, a maximum threshold, or combinations thereof, where the initial number of total users may be known or retrieved by a script 104, FIG. 1 or server 101, FIG. 1 from a file produced or generated by a component of enterprise system 100, FIG. 1. Once an initial number of total enterprise users is known, for example in a scenario where an enterprise has 10,000 registered users, which may be comprised of a mix of employees and contractors, this will be the total number of users of the enterprise, then the total number of required groups for an email and calendar server system deployed by the enterprise can be determined 305 based on this total number of users, and the group size limit that corresponds with a maximum threshold, which is set by the deployed server solution, for example a maximum of 1000 users per group.

In one aspect, the initial number of groups can be determined 305 by dividing the number of total users by the maximum threshold, i.e., the maximum number of users allowed per group, for example 10000 total users/1000 max users per group=10 total groups required. In several embodiments the determining 305 can also add in additional groups as an additional measure to ensure that there is additional availability/headroom or a surplus of groups if more users are generated or added, for example the formula may comprise (total number of users/max threshold)+x number of groups, as well as various other possible permutations that can also be set by the enterprise system. In general aspects, the maximum threshold is set by the server solutions, however in other aspects, it could be set by the enterprise itself.

In some aspects, the determining 305 of the number of groups may comprise additional variables, such as user types, where these different user types may each have a different maximum threshold per group. The number of these user types and their related thresholds and rules can be determined independently or be a part of the maximum threshold. In one non-limiting example, each group may have a minimum and/or 1 user of an “admin type” that is incorporated into the 1000 user max threshold limit, or it may be additional to the max threshold type, so a max threshold may for example be comprised of various numerical thresholds for various types, in the example discussed of 1000 ordinary users and 1 admin type. Thus, in this example a user that is classified as an admin type may be included in a group with 1000 generic users but no admin types. Therefore when discussing determining 305 herein, a max threshold can comprise simple or complex max thresholds (where multiple user t. es and numerical user limits are taken into account). The determining 305 by the automated script may therefore take into account these additional variables and/or rules and incorporate them into determining the number of user group required by the enterprise to place all users into a group associated with the email and calendar server solution.

Furthermore, in several aspects, there may also be a determining of various types of groups as well as determining 305 the total number of groups that are required. Determining the types of groups could be a separate optional step independent from determining 305, or it could be part of determining 305, where determining 305 determines the types of groups required then the number of groups required of each type. Examples of types of groups that may be determined can include groups for email lists, groups for calendar lists, groups for meetings and the like. The types of groups may be set by the deployed email or calendar server solution or by the enterprise system, such as having different types of groups for different department, with different rules for each department, or different groups based on user types, with different functionalities, for example different groups for employees and groups for contractors.

Determining 305 may comprise determining the settings and limits/thresholds imposed by the email and calendar server solution and synchronizing those with enterprise rules to establish the types and numbers of groups required for different user types, for example as discussed above. In several embodiments, once the total number of groups required for all the users is determined 305, then the determined number and/or types of groups are automatically created 310, for example by a bot executing a script 104, FIG. 1.

Once groups have been created 310, the method 300 adds users into groups and can do this via an automated bot executing a script, in some embodiments by first selecting a user from a list of users or from the users in the file received, for example those users in a list or in one or more files containing user name, emails, identifiers, other user data objects, or a combination thereof. In some embodiments, the method 300 then iterates through the users, for example through the users or user objects in the file. Or otherwise for each user in the list of users (for example each user from the total users in a list or file), or at least one user of the list of users, or a subset of users from the list, method 300 determines 315 a total number of users in one or more of the groups that are available. In one embodiment, the script, for each user in the file or list, iterates through the groups sequentially or in some other order (which may be pre-configured) to determine 315 for each group the total number of users included in or registered with that particular group.

If the group being considered under the determining 315 for its current number of users/assigned users is at the max threshold, then another group is considered and has its total number of users determined 315. If the first group has a total user number below the max threshold, then method 300 will assign or add 320 the current user it is assigning to the first group. However, if the first group has a total user number at or above the max threshold, then method 300 will attempt to find another group to assign the user to, for example by iterating through the groups to the next group in a list or of known/available groups. In one example the method 300 will iterate through the groups, and if a subsequent group has a total number of users below the max threshold the user will be assigned or added 325 to the subsequent group. In several embodiments method 300 will determine the total number of users in the subsequent group in the list of known/available groups.

In various embodiments, method 300 then applies steps 320-325 to all or at least a portion of other users in the list of users until it assigns all the users into at least one group. In several optional embodiments, once all the users are added into at least one group (in some aspects a user can be added to two or more groups using the same processes discussed in this disclosure) based on determining a maximum threshold of a number of users in the groups. Then method 300 can include pushing each of these created groups with their added users to the email and calendar server solution/system, for example to a server or node of the server solution.

In several embodiments, if the subsequent group also has a user number that isn't below the maximum threshold, then a new group can be created my method 300, and the user is added to the new group. In several embodiments, method 300 must iterate through all available/known groups, and determine that none of the groups has a total user number below the threshold, and only then a new group can be created, and a user can be added to the new group.

In several aspects the database/mainframe 102, FIG. 1 is synchronized and updated based on the method 300, to ensure that the enterprise system and/or computing devices 103, FIG. 1 are synchronized with the users and groups. This may be done independently by the enterprise system or it can be carried out via the email and calendar server solution. Computing devices 103, FIG. 1 may receive mass email or calendar invites upon completion of method 300 where each group pushes a calendar invite to all users within the group, where the method 300 includes pushing a calendar, email, meeting, or other mass task on a group level capturing all users in the group.

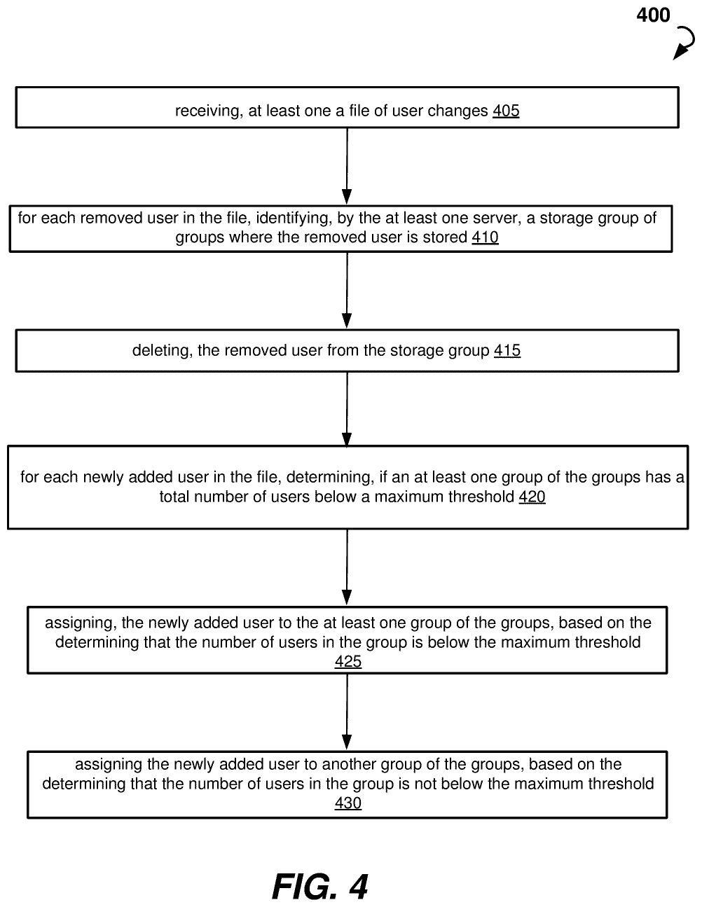

FIG. 4 illustrates one embodiment of a flow diagram illustrating a method for automated maintenance of user and/or groups for an enterprise using an email and calendaring system. With primary reference to FIG. 4 alongside FIG. 1, in several embodiments, method 400 includes receiving 405 a list and/or a file of user changes, for example by a bot or script (e.g. script 104, FIG. 1) running on server, such as the server 101, FIG. 1 from a database or mainframe of the enterprise for example, database/mainframe 102, FIG. 1. This file could for example include user data or user data objects of new or deleted users, such an employees who have recently joined or left the enterprise. Upon the receiving 405, the method 400 can inspect the file received 405, and for each removed user in the file, identifying 410, by the at least one server, a storage group of groups where the removed user is stored. The storage group is the group that the user was previously stored to, registered in, or assigned to, whether by the methods discussed herein or by other methods, e.g., manually by administrator.

Once the group that the user was registered or assigned to has been identified 410, then the user is deleted 415 from that group, for example by the script or bot executing the method 400. Method 400 also can include, detecting or identifying a newly added user that is in the file, i.e., a new user that has recently been added to the enterprise system but is not yet included in a group of the email and calendaring server solution/system. In numerous embodiments, for each newly added user in the received file, or for at least one newly added user in some embodiments, method 400 proceeds to determine 420 if a first group of the plurality of groups has a total number of users below a maximum threshold.

If so, then method 400 assigns or adds 425 the newly added user to the group of the groups, based on the determining that the number of users in the group is below the maximum threshold. Otherwise, method 400 assigns or adds 430 the newly added user to another group of the groups, based on the determining that the number of users in the group is not below the maximum threshold. This methods 400 is automated and capable of being set to be triggered by the server, for example at a specific time of a specific day or date, or be repeated at a specific period, for example once a week or every 2 days and the like. In many embodiments, the maintenance method 400 can be triggered by specific events, such as adding, removing, or modifying a certain number or threshold of users or types of users to the enterprise system, or otherwise maintenance method 400 can be triggered manually by an administrator of the enterprise system.

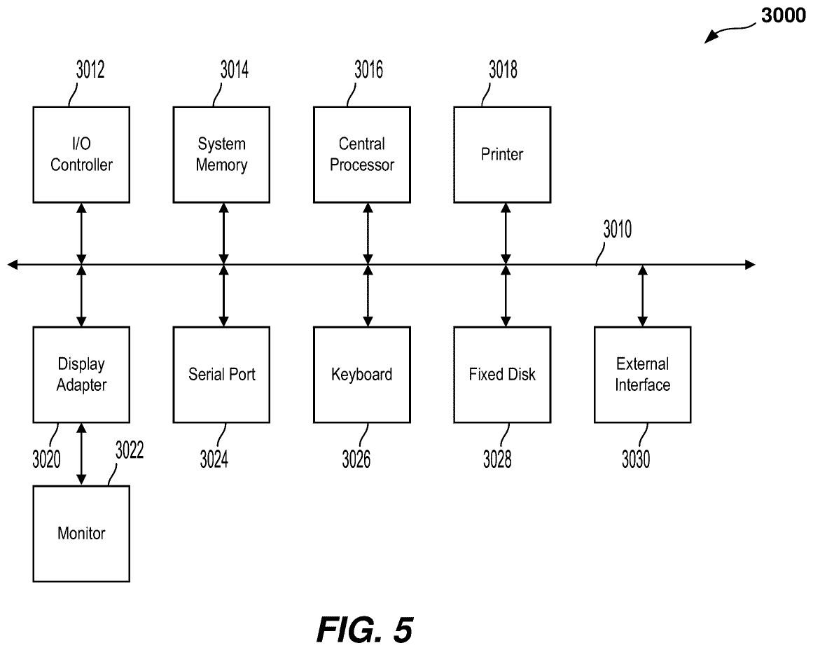

FIG. 5 is a block diagram of a computer apparatus 3000 with data processing subsystems or components, according to at least one aspect of the present disclosure. The subsystems shown in FIG. 5 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024.

For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

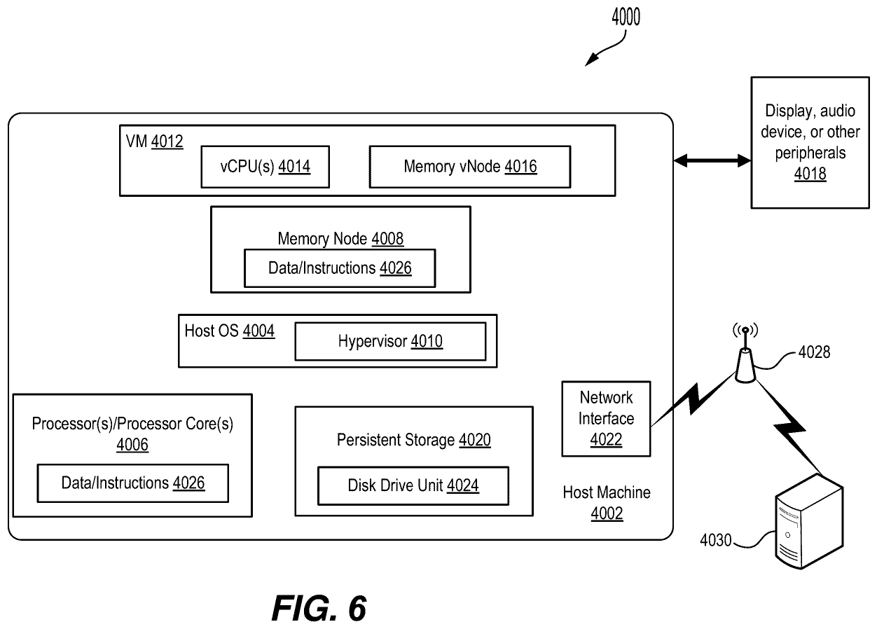

FIG. 6 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 3002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34 bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In one general aspect, therefore, the present invention is directed to computer-implemented systems and methods for automatic group and user management for an enterprise email and calendaring platform. In one embodiment, the method comprises the step of determining, by at least one server, an initial number of user groups for an enterprise for the enterprise email and calendaring platform, based on at least one of an initial total number of users for the enterprise, types of users, or a maximum threshold. The method further comprises the step of automatically creating the user groups of the initial total number, by the at least one server. The method further comprises the step of, for a first user in a list of users: (i) determining, by the at least one server, a current number of users assigned to a first user group of the user groups; and (ii) assigning, by the at least one server, the first user to the first user group, based on the current number of users in the first user group being below the maximum threshold. The method further comprises the step of, for a second user in the list of users: (iii) determining, by the at least one server, a current number of users assigned to a first user group of the user groups; and (iv) assigning the second user to a second user group of the user groups, based on the current number of users in the first user group not being below the maximum threshold.

According to various implementations, the at least one server can push the user groups, by the at least one server, to the enterprise and email calendaring platform.

According to various implementations, the at least one server can determine a current number of users in the second user group, based on the current number of users in the first user group being at or above the maximum threshold.

According to various implementations, the at least one server can further: create a third user group of the user groups based on the current number of users in the second user group not being below the maximum threshold; and assign a third user to the third user group.

According to various implementations, the at least one server can further receive the list of users, by the at least one server, server, from at least one database of the enterprise.

According to various implementations, the maximum threshold is set by the enterprise email and calendaring platform.

According to various implementations, the at least one server can, after assigning the first and second users, for third, fourth and fifth users in the list of users: determine the current number of users in the first user group; assign the third user to the first user group, based on the current number of users in the first user group being below the maximum threshold; assign the fourth user to the second user group, based on the current number of users in the first user group not being below the maximum threshold and the current number of users in the second user group being below the maximum threshold; create a third user group of the user groups based on a current number of users in the first and second user groups not being below the maximum threshold; and assign the fifth user to the third user group.

According to various implementations, the method can further comprise maintaining user management for the enterprise email and calendaring platform, which, in various embodiments, can comprise: receiving, by the at least one server, an electronic file of user changes for the enterprise, wherein the user changes comprise a newly removed user for the enterprise and first and second newly added user for the enterprise; for the newly removed user: (i) identifying a storage user group of the user groups containing the newly removed user; and (ii) deleting the newly removed user from the storage user group; and for the first and second newly added users: (iii) determining a current number of users assigned to at least one user group of the user groups; (iv) assigning the first newly added user to at least one user group, based on the determining that the current number of users assigned to the at least one user group is below a maximum threshold; and (v) assigning the second newly added user to another user group of the user groups, based on the determining that a current number of users assigned to the at least one user group is not below the maximum threshold.

According to various implementations, the maintaining occurs automatically and periodically.

According to various implementations, a periodicity of the maintaining is configurable automatically by an enterprise system, or manually by an administrator or authorized user of the enterprise system.

According to various implementations, the enterprise email and calendaring platform can push at least one electronic calendar to at least one user group of the user groups. The method can further comprise receiving by each user of the at least one user group the calendar into each user's calendaring account. The at least one calendar can comprise at least one of private holidays, public holidays, religious holidays, or individual occasions.

According to various implementations, the maximum threshold comprises at least one of a maximum number of users per user group or users of specific types per user group.

A system according to various embodiments of the present invention comprises: an enterprise email and calendaring platform for an enterprise; at least one enterprise server coupled to the enterprise email and calendaring platform; at least one database coupled to the at least one enterprise server; and at least one user device coupled to the at least one enterprise server. The at least one user device runs a front-end interface of the enterprise email and calendaring platform. The at least one enterprise server is configured to: receive at least one file from the at least one database; read the at least one file; based on the at least one file, execute an automated process to: (i) determine a current number of users in a user group of a set of user groups for the enterprise; (ii) assign at least one user from the at least one file to the user group of the user groups upon a determination that the current number is below a maximum threshold; and (iii) assign at least one user in a subsequent user group of the user groups upon a determination that the current number is not below the maximum threshold.

In various implementations, the at least one file comprises information, data or data objects for at least one of users of the enterprise, user groups of the enterprise, user roles of the enterprise, user activity logs of the enterprise, or system activity logs of the enterprise.

In various implementations, at least one portion of the system is hosted on a cloud network.

In various implementations, the user groups are hosted, or stored by the enterprise email and calendar platform.

In various implementations, the at least one enterprise server is further configured to execute a periodical maintenance job by: receiving a file of user changes from the at least one database; identifying user changes in the file, where the user changes comprise a new user and a removed user; identifying a storage group of the groups where the removed user is stored and delete the removed user from the storage group; determining if a first group of the groups has a current number of users below a maximum threshold, where the maximum threshold comprises at least one of a maximum number of users or users of specific types per group; assigning the new user to the first group upon a determination that the current number of users in the first group is below the maximum threshold; and assigning the new user to another group of groups upon a determination that the current number of users in the group is not below the maximum threshold.

In yet another general aspect, the present invention is directed to a non-transitory computer readable medium comprising instructions that when executed by at least one processor cause the at least one processor to: receive a file of user changes for an enterprise, wherein the user changes comprise a removed user and an added user; identify a storage group of groups where the removed user is stored and deleting the removed user from the storage group; determining if a first group of groups has a current number of users below a maximum threshold, wherein the maximum threshold comprises at least one of maximum number of users per group or users of specific types per group; assigning the added user to the group of the groups upon a determination that the current number of users in the group being below the maximum threshold; and assigning the added user to another group of the groups upon a determination that the current number of users in the group not being below the maximum threshold.

In various implementations, the instructions, when executed by the processor, further cause the processor to: determine an initial number of user groups, based on at least one of an initial total number of users or the maximum threshold; automatically create the user groups of the initial total number; for a user in a list of users, determine a total number of users in a group of the groups; assign the user in the group upon a determination that the total number of users in the group being below the maximum threshold; and assign the user to a subsequent group of the groups upon a determination that the total number of users in the group not being below the maximum threshold.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

Some further descriptions of terms used herein are provided below.

An “application” may include any software module configured to perform a specific function or functions when executed by a processor of a computer. For example, a “mobile application” may include a software module that is configured to be operated by a mobile device. Applications may be configured to perform many different functions. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system. A client or user device may also include an access device as defined in this application.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices may constitute a “system”.

Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “user” may include an individual. In some embodiments or aspects, a user may be associated with one or more personal accounts and/or mobile devices. The user may also refer to a “user data object” associated with a user, or a data object that signifies or identifies a user, where the user object can comprise ‘user information’ or data associated with the user, for example the phrase “adding a user to a group” can signify adding the user data object or data associated to it, including and not limited to user information, metadata, identifiers, tokens or other data related to a user or user data object.

Likewise a “group” can indicate grouping users under a data object or file, or of a data object that signifies a group. The data object related to the group includes and is not limited to information, metadata, identifiers, tokens or other data related to a group or group data object.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.) It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method for automatic group and user management for an enterprise email and calendaring platform, the method comprising:
determining, by at least one server, an initial number of user groups for an enterprise for the enterprise email and calendaring platform, based on at least one of an initial total number of users for the enterprise, types of users, or a maximum threshold;
automatically creating the user groups of the initial total number, by the at least one server;
for a first user in a list of users:
determining, by the at least one server, a current number of users assigned to a first user group of the user groups; and
assigning, by the at least one server, the first user to the first user group, based on the current number of users in the first user group being below the maximum threshold; and
for a second user in the list of users:
determining, by the at least one server, a current number of users assigned to a first user group of the user groups; and
assigning the second user to a second user group of the user groups, based on the current number of users in the first user group not being below the maximum threshold.

2. The method of claim 1, further comprising pushing the user groups, by the at least one server, to the enterprise and email calendaring platform.

3. The method of claim 1, further comprising determining, by the at least one server, a current number of users in the second user group, based on the current number of users in the first user group being at or above the maximum threshold.

4. The method of claim 1, further comprising:
creating, by the at least one server, a third user group of the user groups based on the current number of users in the second user group not being below the maximum threshold; and
assigning, by the at least one server, a third user to the third user group.

5. The method of claim 1, further comprising receiving the list of users, by the at least one server, server, from at least one database of the enterprise.

6. The method of claim 1, wherein the maximum threshold is set by the enterprise email and calendaring platform.

7. The method of claim 1, further comprising, by the at least one server, after assigning the first and second users:
for third, fourth and fifth users in the list of users, determining the current number of users in the first user group;
assigning the third user to the first user group, based on the current number of users in the first user group being below the maximum threshold;
assigning the fourth user to the second user group, based on the current number of users in the first user group not being below the maximum threshold and the current number of users in the second user group being below the maximum threshold;
creating a third user group of the user groups based on a current number of users in the first and second user groups not being below the maximum threshold; and
assigning the fifth user to the third user group.

8. The method of claim 1, further comprising maintaining user management for the enterprise email and calendaring platform, wherein maintaining user management comprises:
receiving, by the at least one server, an electronic file of user changes for the enterprise, wherein the user changes comprise a newly removed user for the enterprise and first and second newly added user for the enterprise;
for the newly removed user:
identifying a storage user group of the user groups containing the newly removed user; and
deleting the newly removed user from the storage user group; and
for the first and second newly added users:
determining a current number of users assigned to at least one user group of the user groups;
assigning the first newly added user to at least one user group, based on the determining that the current number of users assigned to the at least one user group is below a maximum threshold; and
assigning the second newly added user to another user group of the user groups, based on the determining that a current number of users assigned to the at least one user group is not below the maximum threshold.

9. The method of claim 8, wherein the maintaining occurs automatically and periodically.

10. The method of claim 9, wherein a periodicity of the maintaining is configurable automatically by an enterprise system, or manually by an administrator or authorized user of the enterprise system.

11. The method of claim 2, further comprising pushing, by the enterprise email and calendaring platform, at least one electronic calendar to at least one user group of the user groups.

12. The method of claim 11, further comprising receiving by each user of the at least one user group the calendar into each user's calendaring account.

13. The method of claim 11, wherein the at least one calendar comprises at least one of private holidays, public holidays, religious holidays, or individual occasions.

14. The method of claim 1, wherein the maximum threshold comprises at least one of a maximum number of users per user group or users of specific types per user group.

15. A system comprising:
an enterprise email and calendaring platform for an enterprise;
at least one enterprise server coupled to the enterprise email and calendaring platform;
at least one database coupled to the at least one enterprise server; and
at least one user device coupled to the at least one enterprise server, wherein the at least one user device runs a front-end interface of the enterprise email and calendaring platform,
wherein the at least one enterprise server is configured to:
receive at least one file from the at least one database;
read the at least one file;
based on the at least one file, execute an automated process to:
determine a current number of users in a user group of a set of user groups for the enterprise;
assign at least one user from the at least one file to the user group of the user groups upon a determination that the current number is below a maximum threshold; and
assign at least one user in a subsequent user group of the user groups upon a determination that the current number is not below the maximum threshold.

16. The system of claim 15, wherein the at least one file comprises information, data or data objects for at least one of users of the enterprise, user groups of the enterprise, user roles of the enterprise, user activity logs of the enterprise, or system activity logs of the enterprise.

17. The system of claim 15, wherein at least one portion of the system is hosted on a cloud network.

18. The system of claim 15, wherein the user groups are hosted, or stored by the enterprise email and calendar platform.

19. The system of claim 15, wherein the at least one enterprise server is further configured to execute a periodical maintenance job by:
receiving a file of user changes from the at least one database;
identifying user changes in the file, wherein the user changes comprise a new user and a removed user;
identifying a storage group of the groups where the removed user is stored and delete the removed user from the storage group;
determining if a first group of the groups has a current number of users below a maximum threshold, wherein the maximum threshold comprises at least one of a maximum number of users or users of specific types per group;
assigning the new user to the first group upon a determination that the current number of users in the first group is below the maximum threshold; and
assigning the new user to another group of groups upon a determination that the current number of users in the group is not below the maximum threshold.

20. A non-transitory computer readable medium comprising instructions that when executed by at least one processor cause the at least one processor to:
receive a file of user changes for an enterprise, wherein the user changes comprise a removed user and an added user;
identify a storage group of groups where the removed user is stored and deleting the removed user from the storage group;
determine if a first group of groups has a current number of users below a maximum threshold, wherein the maximum threshold comprises at least one of maximum number of users per group or users of specific types per group;
assign the added user to the group of the groups upon a determination that the current number of users in the group being below the maximum threshold; and
assign the added user to another group of the groups upon a determination that the current number of users in the group not being below the maximum threshold.

21. The non-transitory computer readable medium of claim 20, wherein the instructions, when executed by the processor, further cause the processor to:
determine an initial number of user groups, based on at least one of an initial total number of users or the maximum threshold;
automatically create the user groups of the initial total number;
for a user in a list of users, determine a total number of users in a group of the groups;
assign the user in the group upon a determination that the total number of users in the group being below the maximum threshold; and
assign the user to a subsequent group of the groups upon a determination that the total number of users in the group not being below the maximum threshold.
